(19) United States
(12) Patent Application Publication
(10) Pub. No.: US 2007/0075454 A1
(43) Pub. Date: Apr. 5, 2007

(54) COMMON CAVITY, MULTIPLE CORE, INSERT MOLDED TRIM PANEL

(75) Inventors: Glenn A. Cowelchuk, Chesterfield Township, MI (US); David J. Dooley, Troy, MI (US); Todd L. DePue, Brighton, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/163,029

(22) Filed: Oct. 3, 2005

(51) Int. Cl. B29C 45/14

(52) U.S. Cl. 264/255; 264/328.8

(57) ABSTRACT

In at least certain embodiments, the present invention relates to a trim panel made by providing a molding tool system comprising a first mold half, a second mold half, and a third mold half and positioning the first mold half and the second mold half proximate each other to form a first mold cavity. In certain embodiments, the method further comprises introducing a first resin into the first mold cavity to form a trim panel skin and positioning the first mold cavity with the trim panel skin and the third mold half with a trim panel substrate spaced from the trim panel skin to form a second mold cavity. In this embodiment, the method further comprises introducing a second resin into the second mold cavity to form a resilient layer extending between and connecting the trim panel skin and the trim panel substrate.

### BACKGROUND OF THE INVENTION

1. Field of the Invention

The invention relates to motor vehicle interior parts and method of making the same.

2. Background Art

Motor vehicle interiors have many interior components made of panels. Examples of these types of interior components include, but are not necessarily limited to, interior door panels, instrument panel, consoles, console covers, arm rests, other interior trim parts and seats.

The panels employed in these components typically comprise a relatively hard, rigid substrate, a cover skin or layer, and a soft padding disposed between at least part of the substrate and the skin. The soft padding is typically foam. When foam is used, the panel is typically made by placing the cover skin and substrate in a foam mold in a spaced apart arrangement, and then introducing foam into the mold. The foam, upon curing, secures the cover skin to the substrate. This is typically known as a foam in place process.

The skin is typically made in a first mold tool and then transferred to another mold tool for the foaming step. This requires at least two mold tools, each taking up a substantial amount of space. This also requires a removal step adding an extra operator and possible a storage step and space to the process. Also, the foam in place process can be relatively costly as it has a relatively long cycle time.

Accordingly, it would be desireable to provide a trim panel which would overcome at least one of the deficiencies in the prior art.

### SUMMARY OF THE INVENTION

According to one aspect of the present invention, a method making an automobile interior trim panel is provided. In at least one embodiment, the method comprises providing a molding tool system comprising a first mold half, a second mold half, and a third mold half, positioning the first mold half and the second mold half proximate each other to form a first mold cavity, and introducing a first resin into the first mold cavity to form a trim panel skin. In this embodiment, the method further comprises positioning the first mold half with the trim panel skin and the third mold half with a trim panel substrate spaced from the trim panel skin to form a second mold cavity, and introducing a second resin into the second mold cavity, to form a resilient layer extending between and connecting the trim panel skin and the trim panel substrate.

In at least one embodiment of the present invention, the first mold half comprises a tool cavity and the second mold half comprises a first tool core. In at least another embodiment of the present invention, the third mold half comprises a second tool core. In yet at least another embodiment of the present invention, the step of positioning the first mold half with the trim panel skin and the third mold half with a trim panel substrate spaced from the trim panel skin to form a second mold cavity comprises rotating the third mold half towards the first mold half.

In at least one embodiment of the present invention, the first resin comprises a relatively durable material resulting in the skin having a shore A hardness of 50-95. In at least another embodiment of the present invention, the first resin comprises a thermoplastic resin. In yet another embodiment of the present invention, the first resin comprises an elastomer. In still yet another embodiment of the present invention, the first resin is selected from the group consisting of thermoplastic elastomers, styrene-ethylene-butylene-styrene elastomers, blocked copolymer thermoplastic elastomers, polyolefin-based elastomers, foamed thermoplastic elastomers, and combinations thereof.

In at least one embodiment, the first resin is injected into the mold cavity at a temperature from 350° F. to 440° F. and a pressure from about 200 psi to about 2100 psi.

In at least one embodiment of the present invention, the second resin comprises a resin that is less rigid than the first resin. In at least another embodiment of the present invention, the second resin has a shore A hardness of 5-45. In at least yet another embodiment of the present invention, the second resin comprises a blown formed thermoplastic elastomer. In at one embodiment of the present invention, the second resin is injected into the mold cavity at a temperature from about 350° F. to about 440° F. and a pressure from about 200 psi to about 2100 psi.

According to yet another aspect of the present invention, an automobile door panel is provided. In at least one embodiment, the automobile door panel is made in accordance with the method described above.

In yet another embodiment, the method of making an interior trim panel comprises positioning a first mold half and a second mold half proximate each other to form a first mold cavity, and introducing a first resin into the first mold cavity to form a trim panel skin. In this embodiment, the method further comprises providing a third mold half with a trim panel substrate disposed therein, and rotating the third mold half with the trim panel substrate disposed therein to a position proximate the first mold half to form a second mold cavity, introducing a second resin into the second mold cavity to form a resilient layer extending between and connecting the trim panel skin and the trim panel substrate to form a trim panel, and removing the trim panel from the second mold cavity.

In still yet another embodiment of the present invention, the method of making an interior trim panel comprises positioning a first mold half and a second mold half to form a first mold cavity, and introducing a first resin into the first mold cavity to form a trim panel skin. In this embodiment, the trim panel skin has a shore A hardness of 50-95. In this embodiment, the method further comprises rotating a third mold half with a trim panel substrate disposed therein to a position proximate the first mold half to form a second mold cavity, between the trim panel skin and the trim panel substrate, introducing a second resin into the second mold cavity to form a resilient layer having a shore A hardness of 5-45 and extending between and connecting the trim panel skin and the trim panel substrate to form a trim panel, and removing the trim panel from the second mold cavity.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic side view of an automobile interior panel made in accordance with an embodiment of the present invention;

FIG. 2 is a schematic fragmentary sectional view of the automobile interior panel shown in FIG. 1, taken through line 2-2;

FIG. 3 is a schematic cross sectional view illustrating a manufacturing step of the present invention;

FIG. 4 is a schematic cross sectional view illustrating a further manufacturing step of the present invention;

FIG. 5 is a schematic cross sectional view illustrating a further manufacturing step of the present invention; and

FIG. 6 is a schematic cross sectional view illustrating a further manufacturing step of the present invention.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various alternative forms. The figures are not necessarily of scale, some features may be exaggerated or minimized to show details of particular components. Therefore specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within the numerical limits stated is generally preferred. Also, unless expressly stated to the contrary, the description of a group or class of materials as suitable preferred for a given purpose in connection with the invention implies that mixtures of any two or more members of the group or class may be equally suitable or preferred.

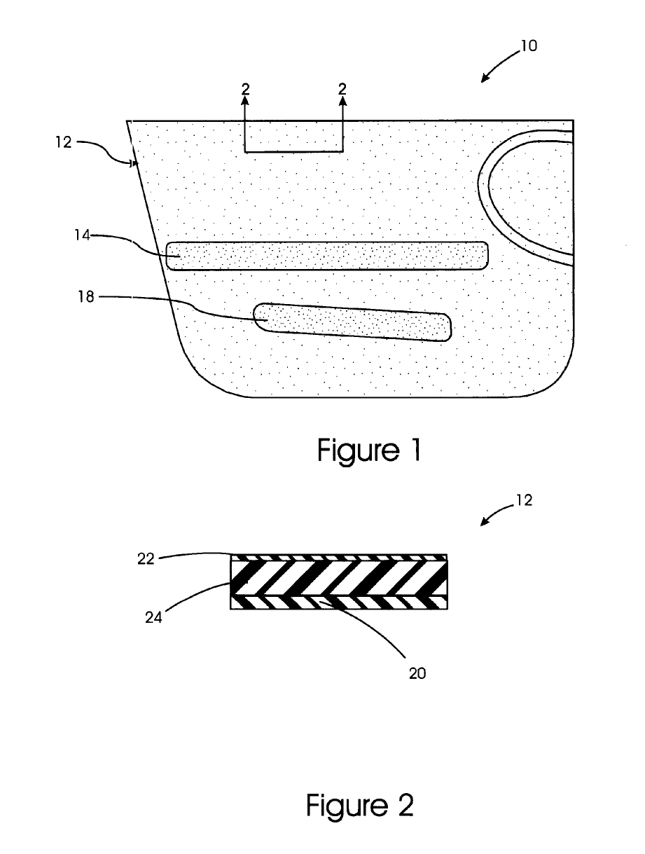

FIG. 1 shows an interior door panel 10 in accordance with at least one embodiment of the present invention. Certain aspects of the present invention will be described below in connection with the door panel 10. However, it should be understood that other trim products, such as instrument panels, glove box door covers, console sides, console covers, arm rests, pillar trim panels, shelves, trim covers and the like may also enjoy the benefits of the present invention.

The door panel 10 includes a major panel 12 which may also include additional structures attached thereto. The door panel 10 can also include additional components such as an armrest 14 and a map pocket 18. In at least the embodiment illustrated in FIG. 1, the armrest 14 is secured to the major panel 12 and the map pocket 18 is formed in the major panel.

With reference to FIG. 2, the schematically illustrated major door panel portion 12 comprises a rigid substrate 20 and a cover layer 22 disposed over at least a portion of the substrate. The major door panel 12 has a resilient layer 24 that is disposed between at least a portion of the substrate 20 and the cover layer 22.

The substrate 20 can be made of any suitable material known to those of ordinary skill in the art. Suitable examples of materials for making the substrate 20 include, but are not necessarily limited to, PP, PE, ABS, TPE, TPU, PC, PC/ABS, SMA, TPO, and combinations thereof. The substrate 20 can be made by any suitable process such as injection molding or compression molding and can take any suitable shape or configuration. In at least one embodiment, the substrate 20 has an average thickness of 1-5 mm, and in other embodiments of 2.5-3.5 mm.

The cover layer 22 can be made of any suitable material known to those of ordinary skill in the art. In at least one embodiment, the cover layer 22 has a shore A hardness of 50-95, in another embodiment of 60-90, and in yet another embodiment of 70-85. Some suitable examples of materials for making the cover layer include, but are not limited to, any suitable relatively non-rigid relatively soft skin layer material such as TPE, TEE, TPU, EPDM, any other suitable elastomeric materials. As will be explained further below, the cover layer 22, in at least one embodiment, is made by injection molding.

Furthermore, the cover layer 22 may have any suitable thickness and density. For example, the cover layer 22 may have an average thickness in the range of 0.4 to 1.5 mm and a density in the range of 0.65 to 2.0 g/cm³. In at least one embodiment, the cover layer 22 has an average thickness in the range of 0.75 to 1.25 mm and a density in the range of 0.75 to 1.20 g/cm³. It should be understood, however, that the cover layer 22 may have varying thicknesses throughout its layer.

An optional coating (not shown) may be disposed over the cover layer 22 to protect the cover layer 22 and/or to provide a decorative surface for the door panel 10. For example, the optional coating (not shown) may be used to inhibit sunlight and/or other ultraviolet light from reaching the cover layer 22. As another example, the optional coating may be used as a paint to provide a desired color and/or texture to the door panel 10. While the optional coating may comprise any suitable material, in at least one embodiment, the optional coating is made of an aliphatic polyurethane composition. Furthermore, the optional coating may have any suitable thickness, such as a thickness of approximately 0.5 to 1.5 mil.

The resilient layer 24 can be made of any suitable material known to those of ordinary skill in the art. In at least one embodiment, the resilient layer 24 has a shore A hardness of 5-45, in another embodiment of 7.5-25, and in yet another embodiment of 10-15. Suitable examples of materials for making the resilient layer 24 include, but are not necessarily limited to, any suitable relatively non-rigid relatively material such as TPE, TPU, EPDM, suitable foam forming materials, and combinations thereof. In at least one embodiment, the resilient layer 24 is less rigid that the cover layer 22.

In at least one embodiment, the resilient layer 24 comprises any suitable blown foamed thermoplastic elastomer, such as blown TPE. Examples of suitable blowing agents, include mechanical and chemical blowing agents.

Furthermore, the resilient layer 24 may have any suitable thickness and density. In at least one embodiment, the resilient layer 24 has a density that is less than that of the cover layer 22. In at least one embodiment the resilient layer 24 has a general thickness of 3.0 to 25 mm, and in at least another embodiment 5 to 15 mm, and in yet another embodiment 6 to 10 mm. It should be understood, however, that the resilient layer 24 may have varying thicknesses throughout its layer. As will be explained further below, the resilient layer 24, in at least one embodiment, is made by injection molding.

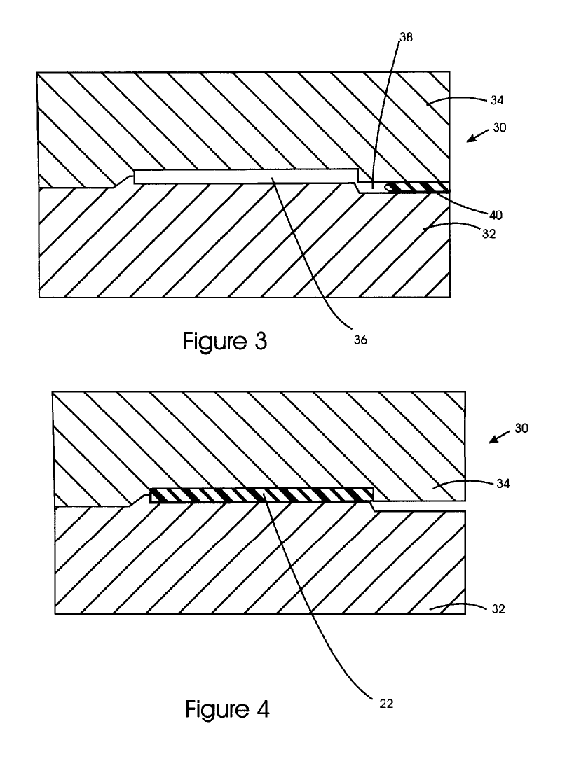

Referring to FIG. 3, a method of making a door panel 10 in accordance with the present invention will be schematically illustrated and described. FIG. 3 illustrates a mold tool 30 having cavity half 32 and a first core half 34. As shown in FIG. 3, when mold tool 30 is closed (i.e., the cavity half 32 and the first core half 34 are brought together), a cavity 36 is formed within the mold tool 30. In at least one embodiment, the mold tool 30 has a channel 38, as is schematically shown in the illustrated embodiment to be generally in the cavity half 32 for communicating with the cavity 36.

Resin 40 is introduced into the mold cavity 36. Typically, the resin 40 is injected into the mold cavity 36 at a temperature from about 350° F. to about 440° F. and a pressure from about 200 psi to about 2100 psi. It should be appreciated that these temperature and pressure ranges will vary depending on the materials used. The resin 40 flows through the mold cavity 36 filling the mold cavity 36, as can be understood from FIG. 4. The resin 40 upon cooling, or curing, forms cover layer 22, as best shown in FIG. 4.

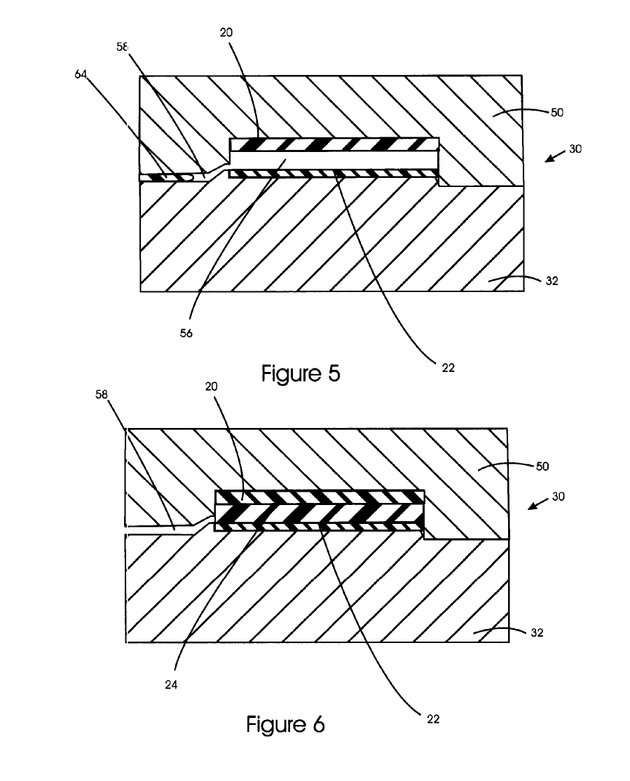

In at least one embodiment the core half 34 is capable of rotational movement relative to the cavity half 32. This allows the core half 34 to rotate away from the cavity half 34 and a second core half 50 to rotate towards and be brought together with the cavity half 32 to form a second cavity 56 as shown in FIG. 5. In this embodiment, the cavity half 32 is stationary.

In a typical process, the substrate 20 is placed within the second core half 50 prior to the second core half 50 being brought together with the cavity half 32. As shown in FIG. 5, the substrate 20 is spaced apart from the cover layer 22. During rotation and subsequent molding, the substrate 20 and cover layer 22 are typically held into place on their respective mold halves 50 and 32 by any suitable means, such as by clips, hooks, or vacuum techniques which are known to those of ordinary skill in the art, or by other suitable means known to those of ordinary skill in the art. After the substrate 22 is in place and the second core half 50 rotated, the mold halves 32 and 50 are closed relative to each other to form the second cavity 56 between the skin 22 and the substrate 20.

A second resin 64, referring to FIG. 5, is introduced into the mold cavity 56. Typically, the second resin 64 is injected into second mold cavity 56 at a temperature from about 350° F. to about 440° F. and a pressure from about 200 psi to about 2100 psi. It should be appreciated that these temperature and pressure ranges will vary depending on the materials used. The second resin 64, upon cooling, or curing, forms the resilient layer 24. In at least one embodiment, the resilient layer 24 is secured to and extends between and connects the substrate 20 and the cover layer 22, as shown in FIG. 6.

In at least the illustrated embodiment, the mold halves 32 and 50 are configured to allow the second resin 64 to dispense into the cavity 56. In at least one embodiment, such as the exemplary embodiment shown in FIG. 5, the halves 32 and 50 cooperate to form a channel 58 to allow the introduction of the second resin 64 into the cavity 56 when the mold halves 32 and 50 are adjacent and abutting each other.

In at least one embodiment, the cover layer 22 can be made of any suitable resin 40 such as a relatively soft resin. Typically, useful resins 40 for the cover layer 22 are thermoplastic resins. Particularly useful resins 40 for the cover layer 22 include, for example, thermoplastic polyurethanes, thermoplastic olefins, polyvinyl chloride, polypropylene, and combinations thereof. More specific examples of useful resins 40 for the cover layer 22 include homopolymers and copolymers of polyethylene, homopolymers and copolymers of polypropylene, filled polypropylene, polycarbonate, acrylonitrile butadiene styrene, mixed acrylonitrile butadiene styrene and polycarbonate, and combinations thereof.

In at least one embodiment, the resin 40 may comprise one or more elastomers. Examples of useful elastomers for the resin 40 include thermoplastic elastomers, thermoplastic urethane, styrene-ethylene-butylene-styrene elastomers, blocked copolymer thermoplastic elastomers, polyolefin-based elastomers, foamed thermoplastic elastomers, and combinations thereof. In at least one embodiment, the first resin 40 comprises TPE and the second resin 64 comprises a softer TPE.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an automobile interior trim panel, said method comprising:
a) providing a molding tool system comprising a first mold half, a second mold half, and a third mold half,
b) positioning the first mold half and the second mold half proximate each other to form a first mold cavity;
c) introducing a first resin into the first mold cavity, the resin, upon cooling, forming a trim panel skin;
d) positioning the first mold half with the trim panel skin and the third mold half with a trim panel substrate spaced from the trim panel skin to form a second mold cavity; and
e) introducing a second resin into the second mold cavity, the second resin, upon cooling, forming a resilient layer extending between and connecting the trim panel skin and the trim panel substrate.

2. The method of claim 1 wherein the first mold half comprises a tool cavity and the second mold half comprises a first tool core.

3. The method of claim 2 wherein the third mold half comprises a second tool core.

4. The method of claim 3 wherein the step of positioning the first mold half with the trim panel skin and the third mold half with a trim panel substrate spaced from the trim panel skin to form a second mold cavity comprises rotating the second mold half away from the first mold half and rotating the third mold half towards the first mold half.

5. The method of claim 1 wherein the first resin comprises a relatively durable material resulting in the skin having a shore A hardness of 50-95.

6. The method of claim 5 wherein the first resin comprises a thermoplastic resin and the skin has an average thickness of 0.5-1.5 mm.

7. The method of claim 6 wherein the first resin is selected from the group consisting of homopolymers and copolymers of polyethylene, homopolymers and copolymers of polypropylene, filled polypropylene, thermoplastic olefins, thermoplastic urethanes, polycarbonate, acrylonitrile butadiene styrene, mixed acrylonitrile butadiene styrene and polycarbonate, and combinations thereof.

8. The method of claim 7 wherein the first thermoplastic resin is selected from the group consisting of thermoplastic elastomers, styrene-ethylene-butylene-styrene elastomers, blocked copolymer thermoplastic elastomers, polyolefin-based elastomers, foamed thermoplastic elastomers, and combinations thereof.

9. The method of claim 8 wherein the first resin comprises thermoplastic elastomer.

10. The method of claim 7 wherein the first resin is injected into the first mold cavity at a temperature from 350° F. to 440° F. and a pressure from about 200 psi to about 2100 psi.

11. The method of claim 1 wherein the second resin is less rigid than the first resin and the resilient layer has an average thickness of 3-25 mm.

12. The method of claim 11 wherein the second resin has a shore A hardness of 5-45.

13. The method of claim 12 wherein the second resin comprises blown foamed thermoplastic elastomer.

14. The method of claim 13 wherein the second resin is injected into the second mold cavity at a temperature from 350° F. to 440° F. and a pressure from about 200 psi to about 2100 psi.

15. The method of claim 13 wherein the substrate is made of a third resin selected from the group consisting of PP, PE, ABS, TPE, TPU, PC, PC/ABS, SMA, TPO, and combinations thereof.

16. An automobile door panel made by the method of claim 1.

17. A method of making a trim panel, said method comprising:
a) positioning a first mold half and a second mold half proximate each other to form a first mold cavity;
b) introducing a first resin into the first mold cavity to form a trim panel skin;
c) providing a third mold half with a trim panel substrate disposed therein;
d) rotating the third mold half with the trim panel substrate disposed therein to a position proximate the first mold half to form a second mold cavity between the trim panel substrate and the trim panel skin;
e) introducing a second resin into the second mold cavity to form a resilient layer extending between and connecting the trim panel skin and the trim panel substrate to form a trim panel; and
f) removing the trim panel from the second mold cavity.

18. The method of claim 17 wherein the wherein the first resin comprises a thermoplastic elastomer having a shore A hardness of 50-95 and is injected into the first mold cavity at a temperature from 350° F. to 440° F. and a pressure from about 200 psi to about 2100 psi and the second resin is less rigid than the thermoplastic elastomer.

19. An automobile door panel made by the method of claim 17.

20. A method of making an automobile interior trim panel, said method comprising:
a) positioning a first mold half and a second mold half to form a first mold cavity;
b) introducing a first resin into the first mold cavity to form a trim panel skin, the first resin having a 50-95 shore A hardness;
c) rotating a third mold half with a trim panel substrate disposed therein to a position proximate the first mold half to form a second mold cavity between the trim panel skin and the trim panel substrate;
d) introducing a second resin into the second mold cavity to form a resilient layer extending between and connecting the trim panel skin and the trim panel substrate to form a trim panel, the second resin having a 5-45 shore A hardness; and
e) removing the trim panel from the second mold cavity.
